(19) United States
(12) Patent Application Publication
(10) Pub. No.: US 2015/0136077 A1
(43) Pub. Date: May 21, 2015

(54) CONTROL STRATEGY FOR ENGINE-OPERATED COMPRESSOR

(71) Applicants: Luis Carlos Cattani, Aurora, IL (US); Michael D. Bartkowicz, Oswego, IL (US); Jayakumar Kirshnaswami, Woodridge, IL (US)

(72) Inventors: Luis Carlos Cattani, Aurora, IL (US); Michael D. Bartkowicz, Oswego, IL (US); Jayakumar Kirshnaswami, Woodridge, IL (US)

(73) Assignee: International Engine Intellectual Property Company LLC, Lisle (IL)

(21) Appl. No.: 14/406,439

(22) PCT Filed: Jun. 8, 2012
(86) PCT No.: PCT/US2012/041757

§ 371 Date: Dec. 8, 2014

(51) Int. Cl. F02D 13/04

(52) U.S. Cl. CPC F02D 13/04
USPC 123/327

(57) ABSTRACT

An engine controller causes a propulsion engine of a motor vehicle to be fueled in a fueling mode of operation and not to be fueled in a non-fueling mode of operation. A controlled device, such as a clutch or regulator, controls operation of a pneumatic compressor which forces compressed air into a storage tank. The controlled device is controlled according to a strategy which distinguishes between the fueling mode and the non-fueling mode for improving overall vehicle fuel economy.

### TECHNICAL FIELD

This disclosure relates to a motor vehicle which has a self-contained pneumatic system including, a pneumatic compressor operated by a combustion engine which propels the vehicle for compressing a gas such as air, at least one tank into which the compressor compresses gas for storage, and at least one pneumatic load, such as air-operated foundation, or service, brakes, which is operated by compressed gas supplied from the at least one tank.

### BACKGROUND

Certain motor vehicles, such as large highway tractors which can tow trailers, have pneumatic-operated foundation brakes. While a particular configuration for, and particular components used in, a pneumatic foundation brake system depend on specifications for a particular vehicle, the pneumatic system in the vehicle would comprise a pneumatic compressor operated by a combustion engine which propels the vehicle and at least one tank into which the compressor compresses gas. Pressure of gas stored in a tank is typically regulated by a control system which operates the compressor to maintain a target pressure range in the tank. Operation of the compressor is controlled by controlling a device such as a clutch or a regulator, depending on the particular type of compressor.

In a system controlled by a clutch, an input shaft of a compressor is coupled through the clutch to an output shaft of the combustion engine. When the clutch is disengaged, the compressor input shaft is disconnected from the engine output shaft, and the compressor does not operate. When the clutch is engaged, the combustion engine output shaft drives the compressor input shaft through the clutch, operating the compressor, which then becomes a load on the engine.

In a system controlled by a regulator, a compressor input shaft is coupled to an engine output shaft. When pressure in a gas storage tank becomes less than some minimum pressure limit, the regulator causes the compressor to operate and compress gas into the tank. When pressure in the tank becomes greater than some maximum pressure limit, the regulator causes the compressor not to operate, although the compressor input shaft may continue to be rotated by the engine output shaft.

### SUMMARY OF THE DISCLOSURE

The present disclosure relates to a pneumatic compressor control strategy which distinguishes between propulsion engine operation in a fueling mode and in a non-fueling mode. for improving overall vehicle fuel economy An engine controller causes a propulsion engine of a motor vehicle to be fueled in a fueling mode of operation and not to be fueled in a non-fueling mode of operation.

A general aspect of the disclosure relates to a motor vehicle comprising a propulsion engine operated by combustion of fuel to propel the vehicle. An engine controller is operable in a fueling mode of operation to cause the engine to be fueled and in a non-fueling mode of operation to cause the engine not to be fueled.

A pneumatic system includes a pneumatic compressor operable by the propulsion engine for compressing a gas, at least one tank into which the compressor compresses gas for storage, and at least one pneumatic load which is operated by compressed gas supplied from the at least one tank.

A controlled device causes the propulsion engine to selectively operate the pneumatic compressor.

A pressure data source provides data indicative of pneumatic pressure in the at least one tank.

A device controller is operable, in the fueling mode of operation, for controlling the controlled device to cause the propulsion engine to start operating the pneumatic compressor when data provided by the pressure data source discloses that pneumatic pressure in the at least one tank has become less than a first pressure, to cause the propulsion engine to continue operating the pneumatic compressor so long as data provided by the pressure data source discloses that pneumatic pressure in the at least one tank is less than or equal to a second pressure which is greater than the first pressure, and for controlling the controlled device to cause the propulsion engine to discontinue operating the pneumatic compressor when data provided by the pressure data source discloses that pneumatic pressure in the at least one tank has become greater than the second pressure.

The device controller is operable, when the engine controller switches from fueling mode of operation to non-fueling mode of operation while data provided by the pressure data source discloses that pneumatic pressure in the at least one tank is less than a third pressure which is both greater than the first pressure and equal to or less than the second pressure, for controlling the controlled device to cause the propulsion engine to start operating the pneumatic compressor and to continue operating the pneumatic compressor so long as data provided by the pressure data source discloses that pneumatic pressure in the at least one tank continues to be less than or equal to the second pressure, and to cause the propulsion engine to stop operating the pneumatic compressor when data provided by the pressure data source discloses that pneumatic pressure in the at least one tank has become greater than the second pressure.

The device controller is operable, when the engine controller switches from fueling mode of operation to non-fueling mode of operation while data provided by the pressure data source discloses that pneumatic pressure in the at least one tank is both equal to or greater than the third pressure and equal to or less than the second pressure, for controlling the controlled device to cause the propulsion engine to continue not operating the pneumatic compressor, and during continuance of the non-fueling mode of operation to cause the propulsion engine to start operating the pneumatic compressor when data provided by the pressure data source discloses that pneumatic pressure in the at least one tank has become less than the third pressure and to cause the propulsion engine to stop operating the pneumatic compressor when data provided by the pressure data source discloses that pneumatic pressure in the at least one tank has become greater than the second pressure.

Still another general aspect relates to a strategy for controlling the controlled device.

### BRIEF DESCRIPTION OF THE DRAWINGS

FIG. 1 illustrates a first embodiment of pneumatic system in a motor vehicle which is propelled by a combustion engine.

FIG. 2 illustrates a second embodiment of pneumatic system in a motor vehicle which is propelled by a combustion engine.

FIG. 3 is a diagram depicting certain modes of operation of a pneumatic system.

FIG. 4 is a diagram graphically illustrating operation in both a fueling mode of operation and a non-fueling mode of operation.

### DETAILED DESCRIPTION

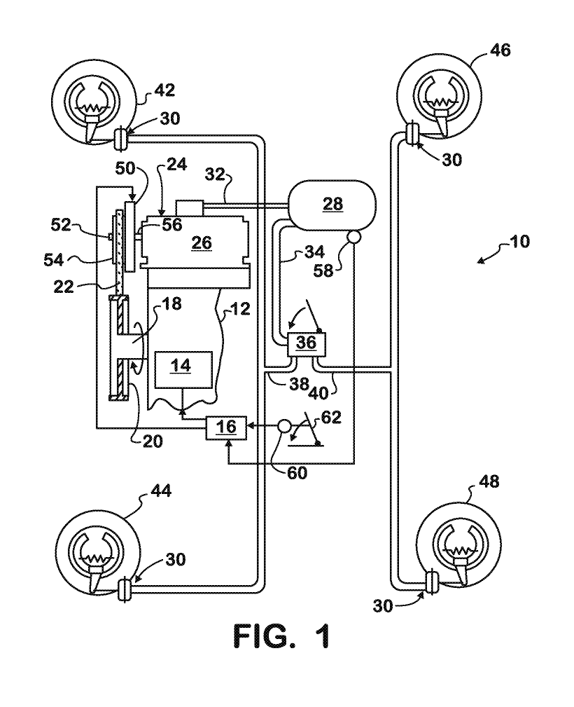

FIG. 1 shows a motor vehicle 10, a highway tractor for example, which is propelled by an internal combustion propulsion engine 12, such as a turbocharged diesel engine for example. Engine 12 is fueled by a fueling system 14 which in the case of a diesel engine comprises fuel injectors for injecting fuel into engine cylinders where the fuel is combusted to operate the engine. Fueling system 14 is controlled by a fueling strategy embodied in an engine controller, or engine control module (ECM) 16, to place engine 12 in either a fueling mode of operation or a non-fueling mode of operation.

As engine 12 operates, the energy of combustion results in the delivery of torque to a crankshaft 18 which is accessible on the engine's exterior for mounting a pulley 20 for rotation with crankshaft 18. Torque can be transmitted from crankshaft 18 to various devices mounted on engine 12 via a drive belt 22 which is trained around pulley 20.

Motor vehicle 10 also comprises a pneumatic system 24 which includes a pneumatic compressor 26 operable to compress a gas, typically air, and at least one tank 28 into which compressor 26 compresses gas for storage.

At least one pneumatic load is operated by compressed gas supplied from tank 28, and FIG. 1 shows four pneumatic- operated foundation brakes 30 which can be operated by compressed gas from tank 28.

When the compressor 26 operates, it forces compressed gas into tank 28 through a conduit 32. Compressed gas is communicated from tank 28 through a conduit 34 to an inlet of a service brake control valve 36 which has two outlets 38, 40. One outlet 38 is communicated to brakes 30 for right and left front wheels 42, 44 of motor vehicle 10 while the other outlet 40 is communicated to brakes 30 for right and left rear wheels 46, 48 of motor vehicle 10.

When a driver of motor vehicle 10 depresses a brake pedal of service brake control valve 36, compressed air is conveyed from tank 28 through brake control valve 36 to brakes 30, causing the brakes to be applied at the four wheels.

A clutch 50 is an example of a controlled device for selectively enabling and unenabling compressor 26 to be operated by engine 12. Clutch 50 comprises an input shaft 52 on which a pulley 54 is mounted so that both input shaft and pulley rotate together. Drive belt 22 is trained around pulley 54 to enable rotation of crankshaft 18 and pulley 20 to rotate input shaft 52 and pulley 54. Clutch 50 comprises an output to which an input shaft 56 of compressor 26 is coupled.

When clutch 50 is disengaged, it does not transmit rotation of its own input shaft 52 to input shaft 56 of compressor 26. When clutch 50 is engaged, it does transmit rotation of its own input shaft 52 to input shaft 56 of compressor 26.

Pressure of compressed air inside tank 28 is measured by a sensor 58 to provide pressure data indicative of pneumatic pressure inside tank 28 to ECM 16.

An accelerator position sensor 60 is associated with an accelerator pedal 62 of vehicle 10 to provide data indicative of the position of accelerator pedal 62 to ECM 16.

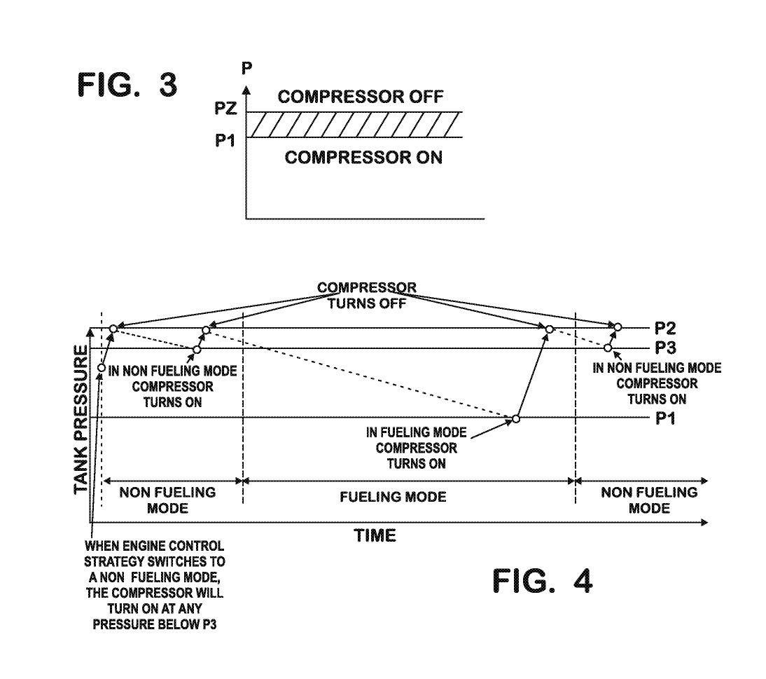

A control strategy for clutch 50, graphically portrayed by FIG. 3, is embodied in ECM 16, although it could be embodied in a separate control module. Whenever data provided by sensor 58 discloses that pneumatic pressure inside tank 28 is greater than a pressure P2, clutch 50 is disengaged, causing propulsion engine 12 not to operate compressor 26. This is “Compressor Off” state. Whenever data provided by sensor 58 discloses that pneumatic pressure inside tank 28 is less than a pressure P1, clutch 50 is engaged, causing propulsion engine 12 to operate compressor 26. This is “Compressor On” state. Whenever data provided by sensor 58 discloses that pneumatic pressure inside tank 28 is both equal to or greater than pressure P1 and equal to or less than pressure P2, how clutch 50 is controlled depends on whether propulsion engine 12 is operating in the fueling mode or in the non-fueling mode as shown by FIG. 4.

In the fueling mode of operation, clutch 50 is engaged to cause propulsion engine 12 to start operating compressor 26 when data provided by sensor 58 discloses that pneumatic pressure inside tank 28 has become less than pressure P1. Engine 12 continues operating compressor 26 so long as data provided by sensor 58 discloses that pneumatic pressure inside tank 28 is less than or equal to pressure P2. Clutch 50 is disengaged to cause engine 12 to discontinue operating compressor 26 when data provided by sensor 58 discloses that pneumatic pressure in tank 28 has become greater than pressure P2.

When ECM 16 switches from fueling mode of operation to non-fueling mode of operation while data provided by sensor 58 discloses that pneumatic pressure inside tank 28 is less than pressure P3 which is both greater than pressure P1 and equal to or less than pressure P2, clutch 50 is engaged to cause engine 12 to start operating compressor 26 and to continue operating compressor 26 so long as data provided by sensor 58 discloses that pneumatic pressure inside tank 28 continues to be less than or equal to pressure P2. Clutch 50 is disengaged to cause engine 12 to stop operating compressor 26 when data provided by sensor 58 discloses that pneumatic pressure inside tank 28 has become greater than pressure P2.

When ECM 16 switches from fueling mode of operation to non-fueling mode of operation while data provided by sensor 58 discloses that pneumatic pressure inside tank 28 is both equal to or greater than pressure P3 and equal to or less than pressure P2, clutch 50 remains disengaged, causing engine 12 to continue not operating compressor 26. During continuance of the non-fueling mode of operation, clutch 50 will become engaged to cause engine 12 to start operating compressor 26 when data provided by sensor 58 discloses that pneumatic pressure inside tank 28 has become less than pressure P3 and will become disengaged to cause engine 12 to stop operating compressor 26 when data provided by sensor 58 discloses that pneumatic pressure in tank 28 has become greater than pressure P2.

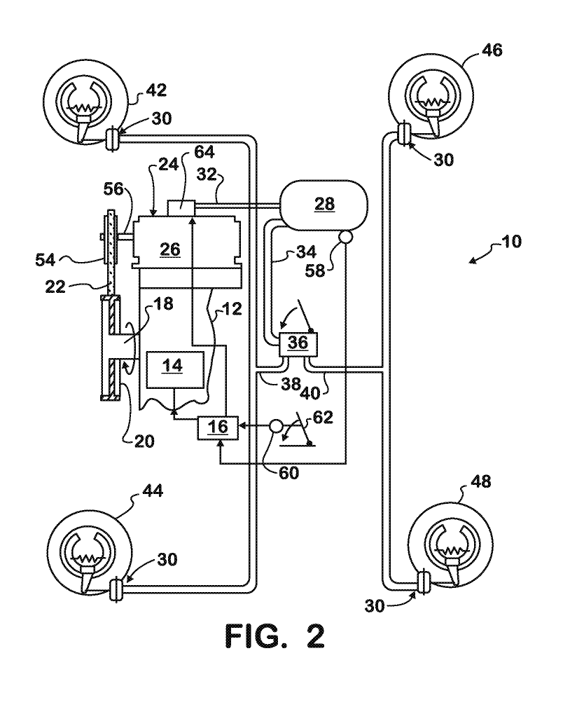

FIG. 2 illustrates a second embodiment in which like reference numerals identify the same elements appearing in FIG. 1. FIG. 2 differs from FIG. 1 is that operation of compressor 26 is controlled by a regulator 64 rather than a clutch. Pulley 24 is mounted directly on input shaft 56 of compressor 26 so that input shaft 56 will always rotate with rotation of crankshaft 18. However, compressor 26 will operate only when allowed by ECM 16 acting on regulator 64.

The strategy can be applied not only to a vehicle having a brake system as described above but to vehicles having various pneumatic loads including other and different types wheel brakes. The strategy can also be applied to other types of compressor drives such as a gear drive which could replace the belt drives shown in FIGS. 1 and 2.

What is claimed is:

1. A motor vehicle comprising:
a propulsion engine operated by combustion of fuel for propelling the vehicle;
an engine controller for causing the propulsion engine to be fueled in a fueling mode of operation and not to be fueled in a non-fueling mode of operation;
a pneumatic system including a pneumatic compressor operable by the propulsion engine for compressing a gas, at least one tank into which the compressor compresses gas for storage, and at least one pneumatic load which is operated by compressed gas supplied from the at least one tank;
a controlled device for causing the propulsion engine to selectively operate the pneumatic compressor;
a pressure data source providing data indicative of pneumatic pressure in the at least one tank;
and a device controller operable, in the fueling mode of operation, for controlling the controlled device to cause the propulsion engine to start operating the pneumatic compressor when data provided by the pressure data source discloses that pneumatic pressure in the at least one tank has become less than a first pressure, to cause the propulsion engine to continue operating the pneumatic compressor so long as data provided by the pressure data source discloses that pneumatic pressure in the at least one tank is less than or equal to a second pressure which is greater than the first pressure, and for controlling the controlled device to cause the propulsion engine to discontinue operating the pneumatic compressor when data provided by the pressure data source discloses that pneumatic pressure in the at least one tank has become greater than the second pressure;
the device controller being operable, when the engine controller switches from fueling mode of operation to non-fueling mode of operation while data provided by the pressure data source discloses that pneumatic pressure in the at least one tank is less than a third pressure which is both greater than the first pressure and equal to or less than the second pressure, for controlling the controlled device to cause the propulsion engine to start operating the pneumatic compressor and to continue operating the pneumatic compressor so long as data provided by the pressure data source discloses that pneumatic pressure in the at least one tank continues to be less than or equal to the second pressure, and to cause the propulsion engine to stop operating the pneumatic compressor when data provided by the pressure data source discloses that pneumatic pressure in the at least one tank has become greater than the second pressure;
and the device controller being operable, when the engine controller switches from fueling mode of operation to non-fueling mode of operation while data provided by the pressure data source discloses that pneumatic pressure in the at least one tank is both equal to or greater than the third pressure and equal to or less than the second pressure, for controlling the controlled device to cause the propulsion engine to continue not operating the pneumatic compressor, and during continuance of the non-fueling mode of operation to cause the propulsion engine to start operating the pneumatic compressor when data provided by the pressure data source discloses that pneumatic pressure in the at least one tank has become less than the third pressure and to cause the propulsion engine to stop operating the pneumatic compressor when data provided by the pressure data source discloses that pneumatic pressure in the at least one tank has become greater than the second pressure.

2. The motor vehicle as set forth in claim 1 in which the controlled device comprises a clutch through which an input shaft of the pneumatic compressor is coupled to an output shaft of the propulsion engine, and the device controller is operable to cause the clutch to selectively connect and disconnect the pneumatic compressor's input shaft to and from the propulsion engine's output shaft.

3. The motor vehicle as set forth in claim 2 in which the at least one pneumatic load which is operated by compressed gas supplied from the at least one tank comprises brakes at wheels of the vehicle.

4. The motor vehicle as set forth in claim 2 in which the at least one pneumatic load which is operated by compressed gas supplied from the at least one tank comprises foundation brakes at wheels of the vehicle.

5. A strategy for controlling, in a motor vehicle, a propulsion engine's operation of a pneumatic compressor for compressing a gas into at least one tank which stores compressed gas for use by a pneumatic load, the strategy comprising:
developing pressure data indicative of pneumatic pressure in the at least one tank;
selectively operating the propulsion engine in a fueling mode of operation by fueling engine cylinders within which fuel combusts to operate the engine and in a non-fueling mode of operation by not fueling the engine cylinders;
while the propulsion engine is operating in the fueling mode of operation, controlling a controlled device to cause the propulsion engine to start operating the pneumatic compressor when the pressure data discloses that pneumatic pressure in the at least one tank has become less than a first pressure, to cause the propulsion engine to continue operating the pneumatic compressor so long as the pressure data discloses that pneumatic pressure in the at least one tank continues to be less than or equal to a second pressure which is greater than the first pressure, and to cause operation of the pneumatic compressor by the propulsion engine to be discontinued when the pressure data discloses that pneumatic pressure in the at least one tank has become greater than the second pressure;
when propulsion engine operation switches from fueling mode of operation to non-fueling mode of operation while the pressure data discloses that pneumatic pressure in the at least one tank is less than a third pressure which is both greater than the first pressure and equal to or less than the second pressure, controlling the controlled device to cause the propulsion engine to start operating the pneumatic compressor and to continue operating the pneumatic compressor so long as the pneumatic pressure data continues to disclose that pneumatic pressure in the at least one tank is less than or equal to the second pressure, and to cause the propulsion engine to stop operating the pneumatic compressor when the pneumatic pressure data discloses that pneumatic pressure in the at least one tank has become greater than the second pressure;
and when propulsion engine operation switches from fueling mode of operation to non-fueling mode of operation while the pressure data discloses that pneumatic pressure in the at least one tank is both equal to or greater than the third pressure and equal to or less than the second pressure, controlling the controlled device to cause the propulsion engine to continue not operating the pneumatic compressor, to cause the propulsion engine to start operating the pneumatic compressor when the pressure data discloses that pneumatic pressure in the at least one tank has become less than the third pressure, and to cause the propulsion engine to stop operating the pneumatic compressor when the pressure data discloses that pneumatic pressure in the at least one tank has become greater than the second pressure.
